(19) United States
(12) Patent Application Publication
(10) Pub. No.: US 2018/0185833 A1
(43) Pub. Date: Jul. 5, 2018

(54) REGENERATION OF CATALYTIC OXIDATION CATALYST IMPREGNATED WITH CHROMIUM

(71) Applicant: Oxy Vinyls, LP, Dallas, TX (US)

(72) Inventors: Keith KRAMER, Andover, KS (US); Joseph A. COWFER, Avon Lake, OH (US)

(73) Assignee: Oxy Vinyls, LP, Dallas, TX (US)

(21) Appl. No.: 15/740,911

(22) PCT Filed: Feb. 8, 2017
(86) PCT No.: PCT/US2017/017011

§ 371 Date: Dec. 29, 2017

Related U.S. Application Data
(60) Provisional application No. 62/292,991, filed on Feb. 9, 2016.

(51) Int. Cl. B01J 38/48; B01J 37/02; B01J 37/08; B01J 23/26; B01J 23/92

(52) U.S. Cl. CPC B01J 38/48; B01J 37/0209; B01J 23/92; B01J 23/26; B01J 37/08

(57) ABSTRACT

A process comprising (i) providing a spent catalytic material; (ii) water washing the spent catalytic material to provide a regenerated catalytic material; and (iii) employing the regenerated catalytic material within a catalytic oxidation process.

This application claims the benefit of U.S. Provisional Application Ser. No. 62/292,991, filed on Feb. 9, 2016, which is incorporated herein by reference

### TECHNICAL FIELD

Embodiments of the invention relate to methods for regenerating catalysts useful in catalytic oxidation processes by water washing the catalyst material.

### BACKGROUND

Catalytic oxidation processes have been employed for disposal of waste organic solvents, ground water pollutants, synthetic by-products, incinerator flue exhaust, and automotive exhausts. In particular applications, catalytic oxidation has been used for treatment of chlorinated hydrocarbons. For example, catalytic oxidation is advantageously employed on a commercial scale to convert chlorinated hydrocarbon by-product or waste streams to carbon dioxide, hydrochloric acid, and water. In certain instances, these products can advantageously be recycled back to the manufacturing process. Moreover, the use of certain catalyst materials allows the catalytic oxidation process to take place at relatively mild conditions (e.g., relatively low temperatures), which allows the catalytic oxidation process to proceed safely and efficiently.

One technical challenge encountered when catalytic oxidation processes are used to treat chlorinated hydrocarbon streams on a commercial scale is the physical loss of the catalyst material (i.e., the physical removal of the active metal species from the catalyst material). As a result of this loss, active metal or derivatives thereof enter the treated product stream, which can present a host of issues. For example, where the treated product stream is recycled or used in a downstream manufacturing process, the catalytic materials from the catalytic oxidation process may cause contamination that results in downstream process inefficiencies. In many instances, the contamination must be removed from the stream prior to recycling back to the manufacturing process. U.S. Pat. No. 5,635,438 proposes a solution to this problem by calcining certain catalysts after impregnating the catalytic support.

In view of the commercial importance of catalytic oxidation, especially the catalytic oxidation of chlorinated hydrocarbon streams, continued improvements are desired.

### SUMMARY

One or more embodiments of the present invention provide a process comprising: (i) providing a spent catalytic material; (ii) water washing the spent catalytic material to provide a regenerated catalytic material; and (iii) employing the regenerated catalytic material within a catalytic oxidation process.

Other embodiments provide a process comprising of (i) oxidizing chlorinated hydrocarbons by contacting the chlorinated hydrocarbons with a catalytic material within a first reactor, where the catalytic material is prepared by impregnating an alumina support with chromium-containing compounds to form an impregnated support, and then calcining the impregnated support; (ii) removing the catalytic material from the reactor; (iii) placing the catalytic material into a vessel; (iv) soaking the catalytic material in water within the vessel; (v) separating the catalytic material from at least a portion of the water to thereby form a regenerated catalytic material; (vi) placing the regenerated catalytic material into a second reactor, where the second reactor optionally includes the first reactor; and (vii) oxidizing chlorinated hydrocarbons by contacting the chlorinated hydrocarbons with the regenerated catalytic material within the second reactor.

### DESCRIPTION OF DRAWINGS

FIG. 1 is a flow chart showing the process of one or more embodiments of the present invention.

FIG. 2 is a fragmented view of a fluid bed reactor employed in one or more embodiments of the present invention.

### DETAILED DESCRIPTION

Embodiments of the present invention are based, at least in part, on the discovery of a process for regenerating catalytic materials used for the catalytic oxidation of chlorinated hydrocarbons. According to one or more embodiments, certain catalytic materials used in the catalytic oxidation of chlorinated hydrocarbons are regenerated by water washing. The catalytic materials include those wherein a catalytic metal is deposited on an alumina support and calcined. It has been discovered that while these catalyst materials undergo less physical loss of active metal species, they nonetheless have limited life, especially when used to treat chlorinated hydrocarbon streams, due to the accumulation of impurities. Advantageously, the washing process of this invention removes at least a portion of these impurities and thereby increases the life span of the catalytic material. Also, the washing process does not remove deleterious amounts of the catalytic metal even though the catalytic metal may derive from aqueous-based compositions. Moreover, the washing process does not remove appreciable amounts of other impurities that are believed to promote catalytic oxidation. For example, while the washing process removes sodium or sodium compounds, which are believed to reduce the efficiency of the catalytic material, the washing process does not remove appreciable amounts of iron or iron compounds that are integrated into the support; it is believed that iron or iron compounds further catalyze the oxidation process.

### Process Overview

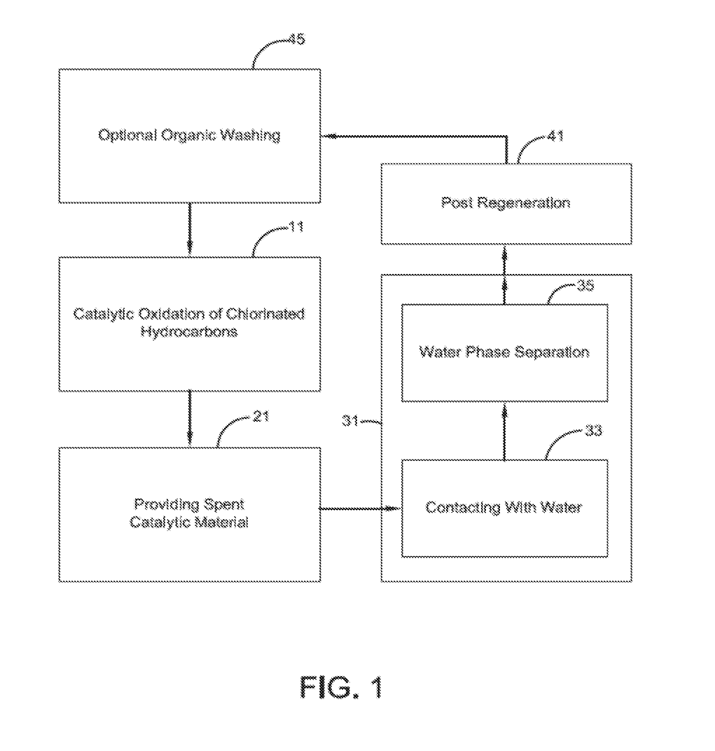

With reference to FIG. 1, the process of one or more embodiments of the present invention may include a step 21 of providing a spent catalytic material. In one or more embodiments, the spent catalytic material may be obtained from catalytic oxidation process 11 wherein the catalytic material has been used in the catalytic oxidation of chlorinated hydrocarbons. The spent catalytic material is regenerated within a regeneration step 31, which may also be referred to as water washing step 31. Following water washing process step 31, the regenerated catalytic material may be processed within an optional post-regeneration step 41, which may include the substep of drying. Ultimately, the regenerated catalytic material may be employed within a catalytic oxidation process 11, such as a process for the catalytic oxidation of chlorinated hydrocarbons (e.g., it may be returned to the same process, or a similar process, from which the spent catalytic material was originally obtained). As suggested in FIG. 1, and as will be described in greater detail below, regeneration step 31 may include a first substep 33 wherein the catalytic material is contacted with water, and a second substep 35 wherein the catalytic material is separated from the water.

### Catalytic Material

In one or more embodiments, the catalytic material, which may also be referred to as catalyst material, is a ceramic particle that has been impregnated with a catalytic metal and subsequently calcined. Catalytic materials of this nature are known in the art as described in U.S. Pat. No. 5,635,438, which is incorporated herein by reference.

In one or more embodiments, the ceramic particle may include alumina, silica-alumina, molybdenum-alumina, activated alumina, silica gel, diatomaceous earths, Fullers earth, kieselguhr, pumice, asbestos, kaolin, bentonite, zeolites, (e.g., zeolites A, X and Y), silica-magnesia-alumina, and chromia-alumina. In one or more embodiments, the ceramic particle includes alumina. Useful forms of alumina are known including those commercially available under the tradenames Catalox and Puralox (Sasol). As generally known in the art, alumina may be agglomerated or fused through a pelletizing or extrusion process for fixed bed reactors, or spray dried and calcined to provide powder for fluid bed applications.

In one or more embodiments, useful alumina has a surface area of from 60 to 250, in other embodiments from about 80 to about 220, and in other embodiments from 100 to 210 square meters per gram (m²/g) prior to impregnation with the metal.

In one or more embodiments, useful alumina may be characterized by a particle size in the range of average diameter from about 30 to about 140, in other embodiments from about 35 to about 120, and in other embodiments from about 40 about 100 microns. Very small particles, or “fines”, having an average diameter below about 20 microns may be excluded in one or more embodiments.

As indicated above, the ceramic particle is impregnated with a catalytic metal. In one or more embodiments, the catalytic metal is chromium in the form of one or more chromium compounds. Suitable chromium compounds include chromium chloride and chromous chloride, chromium oxides (e.g., chromium trioxide) chromium phosphate (e.g., chromic phosphate), chromium acetate (e.g., chromic acetate), chromium formate (e.g., chromic formate), chromium nitrate (e.g., chromic nitrate), chromium bromide (e.g., chromous bromide), chromium carbonate (e.g., chromous carbonate), chromic hydroxide, barium chromate, and potassium dichromate. In particular embodiments, chromium chloride and/or chromic acid are employed. Chromic acid may include those compounds where chromium is in an oxidation state of +6 (i.e., hexavalent chromium). In one or more embodiments, useful specific examples include CrO₃ (chromium trioxide or chromium(VI) oxide), Cr₂O₃ (chromium(III) oxide), CrCl₃ (chromium(III) chloride), and CrCl₆ (chromium(VI) chloride).

In one more embodiments, the catalytic metal is deposited onto the ceramic (i.e., the ceramic is impregnated) by contacting the ceramic particles (e.g., alumina) with an aqueous solution containing the chromium compound (e.g., containing dissolved chromium salts or oxides). After contacting the ceramic particles with metal-containing solution, the particles are typically dried and then calcined at temperatures of from 600° C. to 1200° C. in other embodiments from 700° C. to 1100° C., and in other embodiments from 750° C. to 1050° C.

The amount of chromium metal present on or within the calcined particles can generally range from 0.1% to 30%, or in other embodiments from 2% to 10%, or in other embodiments from 3% to 6% by weight chromium metal based on the entire weight of the catalytic material. In terms of weight percent chromium oxide, 0.3% of chromium oxide is an equivalent of 0.1% on a chromium metal basis; a 2% chromium metal content is equal to 6% on the basis of Cr₂O₃; a 10% chromium metal basis is equal to 29% on the basis of Cr₂O₃. Following impregnation and calcination, the surface area of the catalytic material will typically be in range from 50 to 160 m²/g or in other embodiments from 60 to 140 m²/g.

### Spent Catalytic Material

The term spent catalytic material refers to a catalytic material of the type described above that has reduced catalytic efficiency as a result of use within a catalytic oxidation process. In one or more embodiments, the reduction in catalytic activity results from use within a catalytic oxidation process wherein chlorinated hydrocarbons are oxidized.

In one or more embodiments, the reduction in catalytic activity can be quantitatively defined based upon the increase in the weight of chlorinated organic compounds exiting the catalytic oxidation process where the catalytic material is employed. In one or more embodiments, the spent catalytic material is characterized by at least a 100% increase, in other embodiments by at least a 200% increase, in other embodiments by at least a 300% increase, and in other embodiments by at least a 400% increase in the weight of chlorinated organic compounds exiting the catalytic oxidation process wherein the catalytic materials are employed relative to the chlorinated organic compounds exiting the process when virgin catalytic materials are employed.

In one or more embodiments, spent catalytic material includes those catalytic materials wherein appreciable reduction in catalytic activity or efficiency can be observed. In one or more embodiments, this reduction in catalytic efficiency may include a change (i.e., reduction) in efficiency, as compared to a virgin catalytic material (or in one or more embodiments a regenerated catalytic material), of at least 0.01%, in other embodiments at least 0.1%, in other embodiments at least 0.3%, and in other embodiments at least 0.5%. As the skilled person will appreciate, this reduction in efficiency can be determined by measuring the amount of carbon compounds that are not fully oxidized that pass through the catalytic oxidation process.

In one or more embodiments, the spent catalytic material is a catalytic material of the type described above wherein its use within a process for the catalytic oxidation of chlorinated hydrocarbons results in impurities that have a deleterious impact on the catalytic oxidation process once adsorbed onto the surface of the catalytic material. In particular embodiments, the spent catalytic materials include sodium-containing compounds adsorbed onto the surface of the catalytic material. In one or more embodiments, the spent catalytic materials include at least 0.3 wt %, in other embodiments at least 0.5 wt %, in other embodiments at least 0.7 wt %, and in other embodiments at least 1.0 wt % sodium, based upon the entire weight of the catalytic materials, adsorbed onto the surface of the catalytic materials.

As suggested above, the spent catalytic materials derive from being used in a catalytic oxidation processes. In one or more embodiments, these catalytic oxidation processes treat non-aqueous streams. In particular embodiments, these streams include chlorinated hydrocarbons. Practice of one or more embodiments of this invention is not limited by the type of chlorinated hydrocarbon treated within the catalytic oxidation process. In one or more embodiments, the chlorinated hydrocarbons can include low molecular weight compounds such as those containing from 1 to about 30 carbon atoms, and more typically from 2 to 8 carbon atoms, although higher molecular weight materials may be included. Specific examples of chlorinated hydrocarbons include the various isomers of chlorinated benzene, tetrachlorobutenes, trichloropropenes, waste materials from cracking of ethylene dichloride to vinyl chloride, dichloropropane, dichloroethylene, trichloroethylene, trichloroethane, pentachlorobutane, hexachlorodibenzodioxin, hexachlorodibenzofuran, tetrachlorobiphenyl, the by-product waste stream from the oxychlorination of ethylene, polyvinyl chloride, polyvinylidene chloride, polychloroprene, and chlorinated polyethylene.

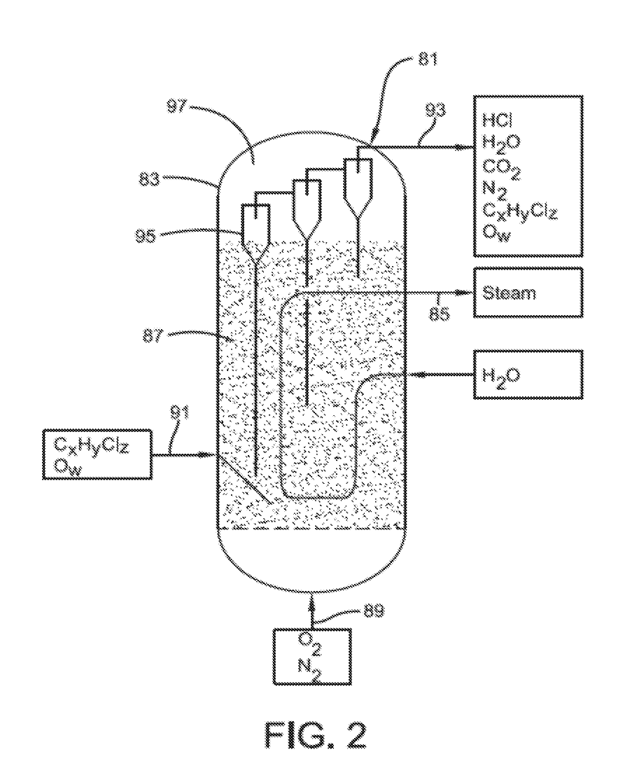

Practice of one or more embodiments of the invention is not necessarily limited by the type of catalytic oxidation process in which the spent catalyst materials were used. In particular embodiments, the spent catalyst materials are obtained from a fluid bed reactor that catalytically oxidizes chlorinated hydrocarbons. A description of a suitable fluid bed reactor and a fixed bed reactor is found in a review article entitled Vinyl Chloride by J. A. Cowfer and A. J. Magistro, Kirk Othmer Encyclopedia of Chemical Technology, Vol. 23, 3rd Ed., (1983), John Wiley, pp. 865-885, which is incorporated herein by reference. Fluidized bed reactors can be cylindrical vessels made of corrosion resistant nickel alloy steel, equipped with internal coils for heat removal (usually as steam) and either internal or external cyclones used for capturing fine catalyst particles. For example, FIG. 2 shows a fluid bed reactor 81 including housing 83, heat exchange tube 85 positioned therein, catalytic material 87, inlet 89 for oxygen and other inert gases (e.g., N₂) for fluidizing the catalytic material, inlet 91 for chlorinated hydrocarbons, and outlet 93 for the products of oxidation. Fluid bed reactor 81, as shown in FIG. 2, includes cyclone apparatus 95 through which the products of the oxidation process are routed and catalytic material entering the freeboard space 97 can be separated from the products of oxidation.

In one or more embodiments, the process of the present invention includes removing the spent catalytic material from the reactor in which the catalytic material is used for catalytic oxidation (of, for example, chlorinated hydrocarbons). As suggested above, this may include, for example, a fluid bed reactor. The spent catalytic material may be stored or otherwise transported in containers, such as hoppers, prior to the water washing step. The step of regenerating may take place within the containers employed for storage or transport, or the spent catalytic material may be transferred to yet another container or vessel in which the spent catalytic material is contacted with water.

### Regeneration of Catalytic Materials

As indicated above, the process of the present invention includes the step of regenerating the catalytic material (e.g., step 31). In one or more embodiments, this step includes contacting the spent catalytic material with water (e.g., substep 33). In one or more embodiments, this step of contacting with water may include one or more steps of soaking the spent catalytic material in water within a batch process. In these or other embodiments, the step of contacting with water may include rinsing the spent catalytic material with water, including drenching the spent catalytic material with moving or flowing water.

In one or more embodiments, the step of contacting the catalytic material with water may include soaking the spent catalytic material within a vessel or container, then decanting the water. This can include a single soaking followed by decanting, or the steps can be repeated multiple times. In one or more embodiments, these steps (i.e., soaking and decanting) can be repeated (i.e., cycled) for at least 2 cycles, in other embodiments at least 3 cycles, and in other embodiments at least 4 cycles. In one or more embodiments, the process may include from 1 to about 10, in other embodiments from about 2 to about 5, and in other embodiments from about 3 to about 4 cycles of soaking and decanting.

In one or more embodiments, the step of soaking may take place for at least 1 minute, in other embodiments at least 30 minutes, in other embodiments at least 60 minutes, and in other embodiments at least 120 minutes. As the skilled person will appreciate, the upper limit of soaking time may only be limited by practical considerations inasmuch as the regeneration efficiencies may be related to the amount of time that soaking takes place. In one or more embodiments, the step of soaking takes place for from about 1 to about 300 minutes, in other embodiments from about 15 to about 120 minutes, and in other embodiments from about 30 to about 90 minutes.

In one or more embodiments, the amount of water used to soak the spent catalytic material may defined in terms of the ratio of the volume of water to the volume of spent catalytic material being treated. As the skilled person will appreciate, the upper limit of useful water may only be limited by practical considerations inasmuch as the regeneration efficiencies are generally related to the amount of water employed. In one or more embodiments, the ratio of the volume of water to the volume of the spent catalytic material is from about 1:1 to about 30:1, in other embodiments from about 2:1 to about 20:1, and in other embodiments from about 3:1 to about 15:1.

In one or more embodiments, the temperature at which the water and catalytic materials are contacted may be in the range from about 10° C. to about 95° C., in other embodiments from about 15° C. to about 85° C., and in other embodiments from about 20° C. to about 50° C.

As suggested above, after the catalytic material is contacted with water, the process of this invention may include a second step of separating the catalytic material and water within a water-phase separation step (e.g., substep 35). In one or more embodiments, this water-phase separation step may include filtration, decanting, and/or centrifugation.

In other embodiments, the step of water washing can take place through a rinse method where, for example, water is continuously introduced to a vessel or container holding the spent catalytic material and after contacting the spent catalytic material, it is continuously removed from the vessel. For example, water can be introduced at the bottom of a vessel holding the spent catalytic material, and the water can simultaneously and continuously be removed from the top of the vessel.

In one or more embodiments, the water employed in the water washing step of the present invention may include treated water of the type that is obtained from a municipal water treatment plant. In other embodiments, treated surface water may be employed, such as that obtained from lakes, rivers, and the like. In other embodiments, the water is further treated to remove impurities within the water. For example, the water may be treated (e.g., filtered) to remove compounds such as silicates, soluble iron species, soluble sodium species, and soluble calcium species. In particular embodiments, distilled water or steam condensate is employed. In particular embodiments, the water employed includes less than 0.2, in other embodiments less than 0.1, and in other embodiments less than 0.05 wt % of total inorganic impurities. In one or more embodiments, the water employed is characterized by a generally neutral pH (e.g., 7.0-8.0), and in other embodiments may be characterized by generally neutral alkalinity (e.g., 8.0-8.5). In one or more embodiments, the water is non-buffered. It has been unexpectedly discovered that the step of contacting the water with the spent catalytic material lowers the pH of the water, which in turn is believed to assist in the regeneration of the catalytic materials.

### Post-Regeneration Treatment

As suggested above, following regeneration step 31, the regenerated catalytic material may be further treated or processed within a post-regeneration step (i.e., step 41). As will be described in greater detail below, this may include drying and/or mechanical treatment. Nonetheless, it has been found that the regenerated catalytic materials can be used directly within a catalytic oxidation process (e.g., a process for the oxidation of chlorinated hydrocarbons) without further modification or treatment. In particular, the catalytic materials can be used without further impregnation of catalytic metals such as chromium or chromium compounds.

In one or more embodiments, the catalytic materials that have been regenerated (e.g., the filtrate or centrate from the water washing process) are dried by exposing the catalytic materials to drying conditions such as those experienced within an oven or by exposure to drying air. In drying the catalytic materials, the catalytic materials may be exposed to drying air (e.g., oven air or forced air drying) having a temperature of from about 50 to about 250, in other embodiments from about 80 to about 175, and in other embodiments from about 90 to about 150° C.

In one or more embodiments, the catalytic materials are dried to the extent that the catalytic materials do not deleteriously agglomerate. In one or more embodiments, the catalytic materials are dried to an extent that the catalytic materials, which are in the form of particles, can be fluidized within a fluid bed reactor.

In one or more embodiments, the catalytic materials are mechanically treated to assist in their further usefulness. For example, in one or more embodiments, the catalytic materials (e.g., dried catalytic materials) can be screened to break up agglomerated particles or to remove unwanted larger particles.

### Optional Organic Washing Step

In one or more embodiments, the process of the present invention optionally includes the step of washing either the spent catalytic material or the regenerated catalytic material with a non-aqueous, liquid organic material (i.e., organic solvent). It is believed that this additional washing step will assist in the removal of water insoluble heavy organic compounds (which presumably block catalyst sites) and thereby further increase the initial activity and efficiency of the regenerated catalyst. In one or more embodiments, the solvent employed within this optional washing step includes a C1 or C2 chlorinated organic solvent such as carbon tetrachloride, ethylene dichloride, chloroform, 1,1,2-trichloroethane, and the like. Advantageously, these organic solvents can be subsequently fed to and treated within the catalytic oxidation process in which the regenerated catalytic material is ultimately returned. In other embodiments, the organic solvent may include C1 to C8 non-aromatic chlorinated organic solvents. In yet other embodiments, the organic solvent may include non-chlorinated C5 to C15 hydrocarbons. As shown in FIG. 1, this optional organic washing step 45 may take place after post regeneration step 41. In other embodiments, this optional washing step may take place prior to or during post regeneration step 41. In yet other embodiments, the optional organic washing step may take place before regeneration step 31. This optional organic washing step is believed to be advantageous because by freeing the catalyst surface of existing organic residue, the catalytic material is believed to be slightly more active and thus upon reactor start-up, lower temperatures are needed to start the process of fully converting feedstock to products. Due to the increased catalyst activity, the heavier organics previously removed from the deactivated catalyst surface can be efficiently combusted upon re-contacting the used solvent to the regenerated or reactivated catalyst.

### Characteristics of Regenerated Catalytic Materials

In one or more embodiments, the regenerated catalytic materials are characterized by their increased activity and ability to be re-employed with a catalytic oxidation process relative to the spent materials. In one or more embodiments, the regenerated catalytic materials are substantially devoid of sodium, which refers to the absence of that level of sodium that would otherwise have an appreciable impact on the catalytic oxidation process. In particular embodiments, the regenerated catalytic materials may be characterized by including less than 0.2, in other embodiments less than 0.1, in other embodiments less than 0.05, in other embodiments less than 0.005 wt % sodium.

In one or more embodiments, the regenerated catalytic materials may be characterized by a water content of less than 10 wt %, in other embodiments less than 5 wt %, and in other embodiments less than 3 wt %.

In one or more embodiments, the regenerated catalytic materials may be characterized by a surface area of from 50 to 240, in other embodiments from about 55 to about 200, and in other embodiments from about 60 to about 160 square meters per gram (m²/g). In these or other embodiments, the regenerated catalytic materials may be characterized by a particle size in the range of average diameter from about 20 to about 150, in other embodiments from about 25 to about 125, and in other embodiments from about 30 to about 110 microns.

In one or more embodiments, the regenerated catalytic materials are characterized by decreased fluid density as compared to the spent catalytic material. In one or more embodiments, the fluid density is at least 0.5%, in other embodiments at least 1.0%, and in other embodiments at least 2.0%, and in other embodiments at least 3.0% lower than the fluid density of the spent catalytic materials as measured within a fluid bed reactor.

Reintroduction into Catalytic Oxidation

As suggested above, the regenerated catalytic materials are reintroduced into a catalytic oxidation process. In one or more embodiments, the regenerated catalytic materials are returned to the same or similar process from which the catalytic materials derived (i.e. the process wherein the catalytic materials were deactivated). In one or more embodiments, the catalytic materials are returned to a process for the catalytic oxidation of chlorinated hydrocarbons including catalytic oxidation of chlorinated hydrocarbons within a fluid bed reactor. In this regard, the discussion above with respect to the catalytic processes that result in deactivation of the catalyst are incorporated herein.

As the skilled person will appreciate, the regenerated catalytic materials can be stored prior to reentry into a catalytic oxidation process. This advantageously allows a production facility to have a ready supply of catalytic material available so that as catalytic material becomes deactivated, the catalytic materials being used in the catalytic oxidation process can be quickly replaced.

In order to demonstrate the practice of the present invention, the following examples have been prepared and tested. The examples should not, however, be viewed as limiting the scope of the invention. The claims will serve to define the invention.

### Examples

Spent catalytic materials were obtained from a commercial catalytic oxidation process wherein the catalytic material was used within a fluid bed reactor for the treatment of chlorinated hydrocarbon streams. Portions of the catalytic material obtained from the commercial process were washed as set forth below, and the washed samples were compared against unwashed samples within laboratory experiments in order analyze the effectiveness of the water washing.

Specifically, the catalytic material was washed by placing 300 gram samples into a 1 L beaker, filling the beaker with distilled water, and stirring the contents at 85° C. for 30 minutes. The water was removed by decanting it from the beaker, and then the process was repeated two additional times. The washed catalytic material was then dried within an oven at 110° C.

To begin with, samples of the washed and unwashed catalytic materials were analyzed using ICP-MS. The unwashed samples showed 0.81% sodium. In comparison, less than 0.005 wt % sodium was detected in the washed samples. The unwashed and washed samples were also analyzed for chromium and iron. The difference in analyzed chromium and iron content was negligible within experimental error. Stated another way, sodium metal was surprisingly removed by water washing, while chromium and iron were not appreciably removed by the water washing.

200 gram samples of the washed and unwashed catalytic materials were charged to a laboratory-scale glass fluid-bed reactor after overnight drying at 110° C. The bed height following reactor loading was recorded prior to fluidization. The reactor was then fluidized at room temperature using two different gas flow rates (13.86 and 5.32 mmol/min of nitrogen). The fluidized bed height was recorded. Qualitatively, the washed material flowed better when being charged to the reactor, and the washed material showed good fluidization quality with small gas bubbles being observed. The unwashed material fluidized to a slightly lower bed height and the fluidization quality was clearly poorer; large gas bubbles or pockets of gas were observed, which is indicative of particle agglomeration. The fluidization of the unwashed material was of a “slugging type” or pulsating flow, while the washed material gave rise to a smooth, even fluidization.

Various modifications and alterations that do not depart from the scope and spirit of this invention will become apparent to those skilled in the art. This invention is not to be duly limited to the illustrative embodiments set forth herein.

1. A process comprising:
(i) providing a spent catalytic material;
(ii) water washing the spent catalytic material to provide a regenerated catalytic material; and
(iii) employing the regenerated catalytic material within a catalytic oxidation process.

2. The process of the preceding claim, where the spent catalytic material includes a ceramic support having a catalytic metal impregnated thereto.

3. The process of claim 2, where the spent catalytic material is prepared by impregnating a ceramic support with a solution containing a soluble form of the catalytic metal, and then subsequently calcining the catalytic material.

4. The process of claim 1, where the spent catalytic material is obtained from a catalytic oxidation process, and where the spent catalytic material is characterized by reduced activity as compared to a catalytic material not previously employed in a catalytic oxidation process.

5. The process of claim 1, where the spent catalytic material is obtained from a catalytic oxidation process wherein chlorinated hydrocarbons are oxidized.

6. The process of claim 1, where the spent catalytic material includes sodium as an impurity.

7. The process of claim 1, further comprising the step of drying the regenerated catalytic material prior to said step of employing the regenerated catalytic material within a catalytic oxidation process.

8. The process of claim 1, further comprising the step of washing the catalytic material or the regenerated catalytic material with an organic solvent.

9. The process of claim 1, where the regenerated catalytic material is substantially devoid of sodium as an impurity.

10. The process of claim 1, where said step of employing the regenerated catalytic material within a catalytic oxidation process includes employing the regenerated catalytic material within a catalytic oxidation process wherein chlorinated hydrocarbons are oxidized.

11. A process comprising:
(i) oxidizing chlorinated hydrocarbons by contacting the chlorinated hydrocarbons with a catalytic material within a first reactor, where the catalytic material is prepared by impregnating an alumina support with chromium-containing compounds to form an impregnated support, and then calcining the impregnated support;
(ii) removing the catalytic material from the reactor;
(iii) placing the catalytic material into a vessel;
(iv) soaking the catalytic material in water within the vessel;
(v) separating the catalytic material from at least a portion of the water to thereby form a regenerated catalytic material;
(vi) placing the regenerated catalytic material into a second reactor, where the second reactor optionally includes the first reactor; and
(vii) oxidizing chlorinated hydrocarbons by contacting the chlorinated hydrocarbons with the regenerated catalytic material within the second reactor.

12. The process of claim 11, where the first and second reactors are the same.

13. The process of claim 11, further comprising the step of drying the catalytic material after said step of separating the catalytic material.

14. The process of claim 11, where the regenerated catalytic material includes less than 0.2 wt % sodium.

15. The process of claim 11, where the regenerated catalytic material includes less than 0.1 wt % sodium.
